(19) United States
(12) Patent Application Publication
(10) Pub. No.: US 2019/0193194 A1
(43) Pub. Date: Jun. 27, 2019

(54) Solid State Extrusion and Bonding Method

(71) Applicant: HYBOND AS, Trondheim (NO)

(72) Inventors: Øystein Grong, Ranheim (NO); Ulf Roar Aakenes, Stjørdal (NO); Tor Gunnar Austigard, Eide (NO)

(21) Appl. No.: 16/301,314

(22) PCT Filed: May 15, 2017
(86) PCT No.: PCT/EP2017/061641

§ 371 Date: Nov. 13, 2018

(30) Foreign Application Priority Data
May 13, 2016 (GB) 1608474.1
May 13, 2016 (GB) 1608475.8
May 13, 2016 (GB) 1608477.4
May 13, 2016 (GB) 1608478.2
May 13, 2016 (GB) 1608479.0
May 13, 2016 (GB) 1608481.6
May 13, 2016 (GB) 1608482.4
May 13, 2016 (GB) 1608483.2

(51) Int. Cl. B23K 20/12; B33Y 10/00; B33Y 30/00

(52) U.S. Cl. CPC B23K 20/128; B33Y 30/00; B33Y 10/00; B23K 20/1245

(57) ABSTRACT

A solid-state method of bonding an extruded bead of metal material (4) onto the surface of a metal substrate (6) is provided. The method comprises deforming the surface of the substrate; extruding extrusion material to form extrudate; and depositing the extrudate on the surface of the substrate to form a bead of material on the substrate which is bonded to the substrate. A solid-state method of joining two metal components (30, 31) is also provided. The method comprises: extruding metal extrusion material to form extrudate (32); depositing extrudate between the two components such that it contacts each of the components to form an initial joint between the components; deforming a surface of the initial joint; and depositing further extrudate (38) on the initial joint between the two components.

The invention relates to a solid state extrusion and bonding method. In particular the present invention concerns a solid-state metal processing method that involves extruding a metal and bonding it to a metal substrate.

A number of techniques are known to be used to join two components together. These techniques include fusion welding, like laser welding, electron beam welding, metal inert gas (MIG) welding, or tungsten inert gas (TIG) welding, friction welding, or a variant known as friction stir welding (FSW), brazing, riveting and adhesive bonding. However, there are various problems with these joining methods which decrease the quality of the joint or make the joining process difficult.

An alternative solid state method for joining components, for example as described in WO 03/043 775, is known which is suitable for joining aluminium (or other light metal) components for structural applications. This method involves removing oxide from the surfaces to be joined immediately prior to extruding a filler material into a gap between the surfaces to be joined to bond the two surfaces to each other. This method may be referred to as a hybrid metal extrusion and bonding (HYB) process. This method is based on the principle of extrusion of a filler/bonding material, and the aim is to reduce or eliminate the disadvantages of prior art methods such as the excessive heating related to the FSW method and/or porosity in the joint which can be created due to the use of shielding gas that is usually required in fusion bonding.

The basic idea behind the HYB process is to enable solid state joining of plates, such as aluminium plates, and profiles using filler material additions without leading to the formation of a weak/soft weld zone (which may be known as a heat affected zone (HAZ)) as in conventional fusion welding and FSW.

It has been realised that there are alternative applications of this solid state hybrid metal extrusion and bonding process.

The method may be performed by an extrusion and bonding tool that is arranged to perform the method.

The present invention may provide a solid state method of bonding an extruded bead/layer of metal material onto the surface of a metal substrate, the method comprising: deforming the surface of the substrate; extruding extrusion material to form extrudate; and depositing the extrudate on the surface of the substrate to form a bead/layer of material on the substrate which is bonded to the substrate.

It has been realised that the hybrid metal extrusion and bonding process can be used to deposit and bond a bead (i.e. layer/strip) of extruded material onto the surface of a substrate rather than being used solely to join two components together using extrudate.

Thus the method may be a method of forming an additional layer on the surface of the substrate.

The extruded bead/layer of material may be bonded only to the substrate onto which it has been extruded, i.e. the extrudate is not used as a filler material in a joint between two components but instead is an additional layer, extruded and bonded onto the surface of a component. The extruded bead may be later joined to other extruded material. Thus, when the extrudate is deposited it may bond only to the substrate onto which it has been extruded.

Thus the extrusion and bonding of the extrudate may not be for the purpose of bonding the substrate to a second substrate but rather just so additional material is deposited on the substrate.

For example, if the substrate is a plate, the method may comprise depositing and bonding extruded extrusion material onto the top planar surface of the plate.

The method may be referred to as bead-on-plate deposition.

The substrate may be a plate and the extruded bead may be bonded to the top planar surface (i.e. the surface of the plate that during deposition of the extrusion material faces the extrusion tool). In other words, the extruded bead is not deposited in a gap or crevice between two components.

The extruded bead of material may be a line of extruded material (e.g. a stringer bead) on the surface of the substrate.

The surface of the substrate that is deformed may be an area of the substrate (i.e. not the entire substrate surface). The area of the surface of the substrate that is deformed may be the same size, or larger than, the area of the extruded bead that is in contact with the substrate.

The step of deforming the surface of the substrate may be done before the extrudate is deposited onto the surface of the substrate. The extrudate may be deposited onto a deformed surface of the substrate. The surface of the substrate may be deformed by the same tool that extrudes the extrusion material.

The extrusion material may be extruded within the tool before being deposited on, or before coming into contact with, the substrate. The substrate may have been plastically deformed by the tool before the extrudate is deposited on, or before the extrudate comes into contact with, the substrate.

The extrusion material may be in the solid state when it is extruded. The extrusion material may be plastically deformed (i.e. plasticised) within the extrusion chamber and/or as it is forced through a die from the extrusion chamber. Thus the method may involve plastically deforming the extrusion material as it is extruded. This may result in deformation of the surface (e.g. surface oxide) of the extrusion material. This may thus result in the removal/dispersion/deformation of a surface layer of the extrudate. This may help promote metallic bonding between the extrudate and the deformed substrate.

The surface of the substrate may be deformed by the deposition of the extrudate. In other words, the deformation of the substrate and deposition of the extrudate on the surface may be simultaneous. For example, the extrudate may be forced onto the surface of the substrate such that the surface of the substrate is deformed. However, in the case the extrusion material may have been plastically deformed before it is forced against the substrate.

The extrusion material and the substrate(s) may each be made from metal. The extrusion material and the substrate(s) may be in the solid state when being processed. The extrusion material and the substrate(s) may not be melted during the extrusion and bonding process. For example, the extrusion material may be extruded in the solid-state and the extrusion material may be deformed and/or plasticised within the extrusion chamber.

The extrusion material and/or substrate(s) may be made of a metal that are plastically deformable and/or workable in their solid state. The extrusion material and/or substrate may be made of aluminium.

The material of the substrate and extrusion material may be different materials. This may be so the method comprises covering/coating/plating a substrate with a different material. For example, the substrate may be steel and the extrusion material may be aluminium so that the method results in depositing aluminium on steel.

The method may also comprise deforming a surface of the bead of material on the surface of the substrate (which may be referred to as a first bead of extrudate); and depositing extrudate on the surface of the bead of material on the substrate (the first bead of extrudate) to form a bead of material bonded (a second bead of extrudate) to the bead of material on the substrate.

In this case, an extruded bead is extruded onto and bonded to an extruded bead that has already been bonded to the surface of the substrate, i.e. a second bead of extrudate is extruded onto and bonded to a first bead of extrudate). This may be referred to as solid-state extrusion and bonding additive layer manufacturing (or additive layer manufacturing, additive manufacturing or 3D printing).

Thus, in another aspect, the present invention may provide a solid-state extrusion and bonding additive layer manufacturing method, the method comprising: deforming a surface of a first bead of metal material; and depositing metal extrudate on surface of the first bead of material to form a second bead of metal material on, and bonded to, the first bead of metal material.

The first bead may be a bead that has been extruded and bonded to a substrate. This may have been extruded and bonded as part of the same operation and/or by the same tool.

The method may also comprise extruding and bonding the first bead onto a substrate. The first bead may be extruded and bonded to the substrate before the second bead is bonded to the first bead.

Thus, in another aspect, the present invention may provide an extrusion and bonding additive layer manufacturing method, the method comprising: deforming the surface of a substrate; extruding extrusion material to form extrudate; depositing the extrudate on the surface of the substrate to form a first bead/layer of material on the substrate which is bonded to the substrate; deforming a surface of the first bead/layer of material on the surface of the substrate; and depositing extrudate on surface of the first bead/layer of material on the substrate to form a second bead/layer of material on the first bead/layer of material on the substrate.

Thus the present invention may comprise stacking and bonding a series of extrusion beads on top of each other.

The method may comprise deforming a surface of the second bead of material bonded to the first bead of material; and depositing extrudate on surface of the second bead of material to form a third bead of material on the second bead of material.

This may be repeated to extrude and bond a fourth, fifth, sixth etc. bead onto the previously extruded and bonded bead.

Thus, the method may comprise deforming a surface of the uppermost bead of material; and depositing extrudate on surface of the previously uppermost bead of material on the substrate to form another (new uppermost) bead of material on the previously uppermost bead of material on the substrate.

The new extruded bead bonded to the previous uppermost bead may be the same width, or smaller than, the previous uppermost bead. For example, the second extruded bead may be the same width as, or narrower than, the first extruded bead which is bonded on the substrate.

This is so that the previous bead on which the new bead is being deposited provides a suitable support and bonding surface onto which the new extruded bead may bond.

The extruded material may be deposited on an area of the substrate that is deformed (either in advance of the deposition or due to the deposition).

Deforming the surface of the substrate may comprise deforming a first area of the surface of the substrate. The bead of material on the substrate may be referred to as a first bead of material on the substrate which is deposited on the first area of the surface of the substrate. In this case the method may comprise deforming a second area of the surface of the substrate; and depositing extrudate on the second area of the surface of the substrate to form a second bead of material on the substrate which is bonded to the substrate.

Again, the deformation of the substrate may occur before the deposition of extruded material or it may be a result of the deposition of the extruded material, i.e. before simultaneous with the deposition. However, the deformation of the solid extrusion metal may occur within the tool before it contacts the substrate.

Thus, in another aspect, the present invention may provide a solid-state method of bonding extruded beads of metal material onto the surface of a metal substrate, the method comprising: deforming a first area of the surface of the substrate; extruding extrusion material to form extrudate; depositing the extrudate on the surface of the substrate to form a first bead of metal material on the first area of the surface of the substrate which is bonded to the substrate; deforming a second area of the surface of the substrate; and depositing extrudate on the second area of the surface of the substrate to form a second bead of metal material on the substrate which is bonded to the substrate.

The second area may be spaced from the first area of the surface of the substrate such that the second bead of material is spaced from the first bead of material.

Alternatively, the first and second areas may not be spaced from each other. In this case, the deposited beads may be in contact with each other.

The first and second beads of material may be spaced from each other to form a channel therebetween. In this case, the method may comprise: deforming the surfaces of the channel; and depositing extrudate in the channel to form a third bead of material on the substrate which is bonded to the substrate and the first and second beads of material.

The steps of deforming the surfaces of the channel; and depositing extrudate in the channel to form a third bead of material on the substrate which is bonded to the substrate and the first and second beads of material may be equivalent to forming a butt joint between the first and second beads of extruded material using the extrusion and bonding technique.

Thus the method may be regarded as a combination of surface deposition and butt joining to form an extruded plate on the surface of the substrate.

The first, second and third beads may together form a plate on the substrate. Thus, the method may be referred to as a plate surfacing technique.

The process of depositing layers of material on the substrate which are spaced apart may be repeated more than two times so as to create a series of channels. The series of channels may each be deformed and have extrudate extruded therein to form the surface plate on the substrate. The surface plate may cover the entire, or substantially the entire, surface of the substrate.

The material of the substrate and extrusion material may be different materials, i.e. different metals. This may be so the method comprises covering/coating/plating a substrate with a different material. For example, the substrate may be steel and the extrusion material may be aluminium so that the method results in plating aluminium on steel.

In another aspect the present invention may provide a method of joining two components, the method comprising: extruding extrusion material to form extrudate; depositing extrudate between the two components such that it contacts each of the components to form an initial joint between the components; deforming a surface of the initial joint: and depositing further extrudate on the initial joint between the two components.

Thus the method may comprise depositing a first bead of material between two components to form an initial joint. Plastically deforming the deposited first bead of material (i.e. the first joint) and depositing a second bead on top of the deformed initial joint such that the first bead and second bead can metallically bond to each other. This can be used to form a multi-pass joint between the two components.

The method may comprise deforming the surface of, at least one, or each of the components which are to be joined.

The first bead may bond to the first and/or second components.

The further extrudate may form a first bead on the initial joint. The first bead may form a first channel between itself and one of the components and/or a second channel between itself and the other of the components. The method may comprise: deforming the surfaces of the first channel; and depositing extrudate in the channel to form a second bead which is bonded to the initial joint, one of the components and the first bead of extrudate.

If a second channel is formed, the method may comprise deforming the surfaces of the second channel; and depositing extrudate in the channel to form a third bead which is bonded to the initial joint, the other of the components and the first bead of extrudate.

The initial joint, and first, second and (if present) third beads together may form a joint between to the two components.

The first, second and (if present) third beads together may form a second layer on the initial joint (which may be referred to as a first layer).

Such a joint may be referred to as a multi-pass joint.

Such a multi-pass joint may be useful in joining thick components which cannot be effectively joined with a single pass.

The initial joint may be a butt joint or fillet joint (depending on the geometry) between the two components.

The first bead may be an additional layer formed on the initial joint.

The second and/or third beads may be effectively butt joins between the first bead and one of the components.

Thus the multi-pass joining method may be considered to comprise fillet and/or butt joins and additive layers.

The components may be referred to as substrates. The components/substrates may be plates.

The multi-pass joint may comprise more than two layers, for example, further extrudate (i.e. a fourth bead) may be extruded and bonded to the first, second and/or third beads.

This further extrudate may be bonded to the join surfaces of the components by further beads (which for example may be beads formed by deposition on a surface and/or butt and/or fillet joining) to form a third layer on the second layer of the joint.

The two components may be located relative to each other so as to form a gap between the surfaces of each of the components to be joined.

Thus the method may comprise locating two substrates (e.g. components such as plates) so that the faces of the substrates to be joined, face each other and are a distance apart to form a gap therebetween.

The surface of each of the components which are to be joined may be angled relative to each other. Thus, the gap may have a varying width in a direction into the joint. For example, the gap may be smallest at the bottom of the joint (where the initial joint is formed) and largest at the uppermost surface of the gap (where multiple passes may be used to form a layer between the two components). For example, the gap (in cross-section) may be V-shaped. The initial joint may be formed in the apex/narrowest part of the V-shaped gap.

In another aspect the present invention may provide a solid-state method of joining two metal components, the method comprising: extruding metal extrusion material to form extrudate; depositing extrudate from a first direction between the two components to form a first joint between the components; and depositing further extrudate from a second direction between the two components to form a second joint between the components.

This may be referred to as a double-sided joint.

The two components may be joined by the fact that the extrudate is bonded to a surface of each of the components.

The first direction may be opposite, or substantially opposite, to the second direction.

The method may comprise forming the first joint and then forming the second joint, i.e. the joins are made sequentially.

The same tool may be used to form each joint. For example, the tool may form the first joint and then be used to form the second joint.

The directions may be relative to the two components. A tool that performs the extrusion and bonding may be moved to change the direction relative to the plates that the extrudate is deposited. Alternatively, the tool that performs the extrusion and bonding may be stationary and the two components moved (such as flipped over) to change the direction that the extrudate is deposited relative to the two components.

The method may comprise deforming (at least a part of) the surface of each of the components which are to be joined. This may be done from each direction.

When the deformation is performed from the second direction (i.e. after the first joint has been formed) the method may comprise deforming an underside part of the initial joint in addition to one or more of the components being joined.

The first joint may be formed by depositing extrudate from a first surface of the two components and/or the second joint may be formed by depositing extrudate from a second surface of the two components.

The first joint and second joint may meet at a position between (e.g. the centre) the opposite surfaces of the components. Thus the first joint and the second joint may together form a double-sided joint.

The two components may be located relative to each other so as to form a gap between the surfaces of each of the components to be joined.

The surface of each of the components which are to be joined may be parallel or substantially parallel to each other.

The surface of each of the components which are to be joined may be angled relative to each other. Thus, the gap may have a varying width in a direction into the joint. For example, the gap may be smallest at, or towards, the centre of the joint (where the initial joint is formed) and largest at the uppermost surface of the gap. For example, the gap (in cross-section) may be the shape of two Vs in which the apex/narrowest part of the Vs meet at, or towards, the centre of the gap between the two plates. The first joint may be formed in the apex/narrowest part of one of the V shapes. The second joint may be formed in the apex/narrowest part of the other of the V shapes.

In the case of a double-sided joint, the joint on each side may be a multi-pass joint as described above. A multi-pass joint may be formed from one side and a multi-pass joint may be formed from the other side.

This may be particularly useful when very thick plates are to be joined.

Alternatively, the joint on each side may be a single pass joint. For example, the joint on each side may be a single pass butt joint.

A double sided joint (irrespective of whether each joint is a single pass joint or a multi-pass joint) may be used to help obtain the required (such as smooth) finish on each side of the joint. Thus, a double sided joint may be performed even if relatively thin components are being joined (i.e. this technique is not necessarily performed only when thick components are being joined).

The present invention may provide an extrusion and bonding tool which is suitable for performing one or more of the above described methods. The extrusion and bonding tool may be for extruding an extrusion material and bonding the extrusion material to a substrate. The tool may be arranged to extrude an extrusion material and deposit it on a substrate such that the extruded extrusion material bonds to the substrate. In other words the bonding and extrusion tool may be a tool for carrying out a hybrid metal extrusion and bonding (HYB) process.

The present invention may provide a method of using an extrusion and bonding tool to perform one or more of the above described methods.

When the method is a method for joining two components, the tool may be moved along a gap between the two components such that a continuous joint is formed between the components by the surfaces being deformed and then each bonded to the extruded extrusion material.

For each aspect, the step of deforming the surface may comprise plastically deforming the metal substrate and/or removing a surface layer, such as a surface oxide, from the substrate. This may promote metallic bonding between the metal extrusion material and the substrate due to oxide dispersion and/or shear deformation.

During the method no part of the tool, e.g. a rotating spindle, may be fully submerged in the substrate (i.e. not surrounded on its entire circumference) but rather only an edge portion of the spindle may be used to deform the surface of the substrate. Thus the method may not be a friction stir welding method in which a deforming component is submerged in the substrate and moves through a part of the bulk component near the surface to be joined. Instead, the present invention may concern a method using just a portion of the spindle to deform/remove a surface layer of the substrate so as to facilitate bonding.

Also in contrast to friction stir welding, in the case that the method comprises joining two components together, there may be a gap between the two components. Further, the extrusion material may be plasticised within the tool before it contacts the substrate rather than being plasticised by contact with the substrate as in typical friction stir welding involving a filler material.

The rotatable spindle (if present) may be rotated at a speed of 100 to 900 rpm, 200 to 600 rpm, 300 to 500 rpm or about 400 rpm. The precise speed may depend on a number of factors such as the tool advancement speed or the material properties.

One or more of these features (and optionally other features of the tool and method) may mean that the temperatures of the materials being joined with the present method may be maintained at a lower temperature (such that the joint quality may be improved) than with friction stir welding. Also, the forces being applied during the method by the tool and/or rotating spindle may be less.

The deformation step may be done before the extrudate is deposited onto the surface of the substrate. The extrudate may be deposited onto a deformed surface of the substrate. The surface of the substrate may be deformed by the same tool that extrudes the extrusion material. For example, the tool may have a part, such as a rotating spindle, which is used both to extrude the material and deform the surface. The spindle may thus have a dual function of causing extrusion of the extrudate and deformation of the substrate. These two steps may occur concurrently.

Rotation of the spindle may cause a dispersion or deformation of the surface layers on both the substrate and the extrusion material.

Alternatively, the surface on which the extrudate is deposited may be deformed by the deposition of the extrudate. In other words, the deformation of the substrate and deposition of the extrudate on the surface may be simultaneous. For example, the extrudate may be forced onto the surface of the substrate such that the surface of the substrate is deformed.

The extrudate may be extruded onto a surface such that it bonds to the surface onto which it is extruded.

The substrate/component(s) may be a light metal, such as aluminium (including aluminium alloys). The substrates/components may be the same material. If both substrates/components are aluminium they may be the same or different grades of aluminium.

The substrate/component(s) may be a non-light metal, such as steel.

When the method is a method joining two substrates together the two substrates may be the same material. The substrates/components may have an identical composition as each other. Alternatively, the two substrates may be different materials. For example, one substrate may be a light metal such as aluminium and the other substrate may be a non-light metal such as steel.

The extrusion material may be a filler material, such as a filler wire.

The extrusion material may be aluminium (including aluminium alloys). The extrusion material may be the same material as the substrate (or in the case when two substrates are being joined, the same as at least one of the substrates).

Alternatively, the extrusion material may be different to the material of the substrate(s).

The extrusion material may change during the method.

For example, in the case of additive manufacturing, beads closer to the substrate may be one material, whereas beads further from the substrate may be a different material. In the case of multi-pass joining, the initial joint may be formed of a first material and subsequent layers may be formed of a different material.

In the case that two components are being joined together the extrusion material may be a filler material which fills a gap between two substrates. The extrusion material may join two materials together. This may be achieved by the extruded material bonding to both substrates.

The above described methods may be performed at room temperature. The method may comprise not using any heating means or adding extra heat to the environment other than the heat generated by the process itself, e.g. extrusion and/or friction (e.g. between the extruder and the substrate and/or extrusion material). For example, during the method heat may be conducted from an extrusion chamber through the die opening (through which the extrusion is performed) to the substrate/component on which the extrusion material is deposited.

It may be desirable for there to be a sufficient supply of heat to the substrate(s) to avoid excessive work hardening of the extrusion material during bonding, yet it is desirable that the heat is supplied only to a restricted volume of the substrate underneath the extruder head.

Heat may be supplied via the extrudate and through conduction and mechanical work of the tool in contact with the substrate.

The method may comprise cooling the tool and/or substrate during extrusion and bonding. For example, the method may comprise cooling, e.g. water cooling, the tool, substrate and/or extrudate whilst the tool is being used.

The cooling may be performed using a water cooling means. The cooling means may use a fluid other than water. For example the cooling means may be CO₂ or helium.

The cooling fluid may be directed against the tool and/or extruded material for example. In the case of CO₂, the fluid may be a liquid within the cooling means and then transform into a gas just before, as or after it impinges on the part (e.g. tool itself or the materials being bonded) to be cooled.

The method may be a combination of one or more of the above methods. The method may comprise extruding extrusion material between two substrates (e.g. plates or components) to join the two substrates together and/or the method may comprise depositing extrudate on the surface of a substrate (e.g. the surface of a plate or component).

The method may comprise one or more of: butt joining two components, fillet joining (which encompasses, T, corner and lap joining) two components, multi-pass joining two components, depositing a stringer bead on the surface of a component, depositing a layer on a substrate, double sided joining and/or additive layer manufacturing.

When the method comprises a plurality of different applications/techniques different tools may be used for different stages of the process. Alternatively, a single tool may be used. The single tool for performing the method may comprise interchangeable parts which can be changed depending on the application the bonding and extrusion tool is to be used for.

For example, the tool may comprise an extruder head which can be changed depending on the application the tool is intended to be used for. Thus, a plurality of extruder heads may be provided. Each extruder head may be for a different bonding and extrusion application.

Each extruder head may have a specific geometry suited for the application the tool will be used for.

For example, an extruder head designed for butt joining, an extruder head designed for fillet joining, an extruder head designed for bead-on-plate deposition, and/or an extruder head designed for additive layer manufacturing may each be provided.

Thus, the tool may comprise a plurality of interchangeable extruder heads which are each designed for a different application. Each different application involves extruding an extrusion material and bonding it to a substrate.

Because the tool can be used for a plurality of different applications (including butt joining, fillet joining, multi-pass joining, double sided joining, bead-on-plate deposition, and/or additive layer manufacturing) the tool may be used in applications which require a combination of these different techniques. For example, the tool may be used for plate surfacing which may be performed by depositing separated beads on the substrate and then butt joining adjacent deposited beads together. The tool may be used for multiple pass joining which may comprise fillet joining, depositing a bead on the fillet joint and butt joining the deposited bead on each side to the substrates being joined.

The method may comprise changing the extruder head of the tool during performing a joining and/or deposition technique.

The tool may comprise a drive mechanism which can engage with the, or each, extruder head. The drive mechanism and an extruder head may together form the bonding and extrusion tool.

Thus, in another aspect the present invention may provide a kit of parts for a bonding and extrusion tool for carrying out a solid-state hybrid metal extrusion and bonding process, wherein the tool is for extruding a metal extrusion material and bonding the extrusion material to a metal substrate, the kit of parts comprising: a drive mechanism; and a plurality of extruder heads, wherein each extruder head can be driven by the drive mechanism; and wherein the drive mechanism and one of the extruder heads together form the bonding and extrusion tool.

The present invention may provide an extruder head which is designed for butt joining two substrates. Such an extruder head may be referred to as a butt joining extruder head.

A butt joining extruder head may be designed to join two substrates. The two substrates may have top surfaces that are substantially in the same plane as each other and may be separated from each other by a gap. The substrates may each have an upper surface, which is the surface that faces the main body of the tool during use. The substrates each may have a join surface which face each other and bound the gap between the two substrates. The upper surface and join surfaces of each of the two substrates may be at an angle to each other, such as between 45 and 90 degrees to each other. The join surfaces may be parallel to each other.

The present invention may provide an extruder head which is designed for fillet joining two substrates. Such an extruder head may be referred to as a fillet joining extruder head.

A fillet joining extruder head may be designed to join two substrates which extend at an angle relative to each other. The substrates may each have a first surface, which is the surface that faces the main body of the tool during use. The first surfaces of the two substrates may be at an angle to each other. The substrates each may have a join portion which is located near/in close proximity to the other substrate.

The fillet joining extruder head may comprise a support/sealing surface which in use contacts and seals against the two substrates. The sealing surface may reduce extruder material flash formation on the surface of the substrates during joining.

The seal surface may comprise a first seal portion which in use seals against a first of the two substrates and a second seal portion which in use seals against the other (i.e. a second) of the two substrates.

The present invention may provide an extruder head which is designed for bead-on-plate deposition. Such an extruder head may be referred to as a bead-on-plate extruder head.

A bead-on-plate extruder head may be designed to deposit a bead of extrudate on the surface of a substrate. The substrate may have a deposition surface, which is the surface that faces the main body of the tool during use and the surface on which the extruded extrusion material will be deposited.

The present invention may provide an extruder head which is designed for additive layer manufacturing. Such an extruder head may be referred to as an additive layer manufacturing extruder head.

An additive layer manufacturing extruder head may be designed to deposit a bead of extrudate on a bead that has already been deposited on substrate. Thus, the substrate that the tool deposits onto may be a bead already deposited by the tool.

The method may comprise providing a tool with one or more, such as two or more of a butt joining extruder head, a fillet joining extruder head, a bead-on-plate extruder head and/or an additive layer manufacturing extruder head.

The method of bonding an extruded bead of material onto the surface of a substrate may comprise using a bead-on-plate extruder head. The bead-on-plate extruder head may be used to deform the surface of the substrate; extrude extrusion material to form extrudate; and deposit the extrudate on the surface of the substrate to form a bead of material on the substrate which is bonded to the substrate.

The extrusion and bonding additive layer manufacturing method may comprise using a bead-on-plate extruder head and an additive layer manufacturing extruder head. The bead-on-plate extruder head may be used to form an initial bead on a substrate and the additive layer manufacturing extruder head may be used to deposit one or more subsequent beads on top of each other on top of the initial bead. For example, the bead-on-plate extruder head may be used to deform the surface of a substrate; extrude extrusion material to form extrudate; and deposit the extrudate on the surface of the substrate to form a first bead of material on the substrate which is bonded to the substrate. The additive layer manufacturing extruder head may be used to deform a surface of the first bead of material on the surface of the substrate; and deposit extrudate on surface of the first bead of material on the substrate to form a second bead of material on the first bead of material on the substrate. The method may comprise using the bead-on-plate extruder head to extrude and deposit the initial bead, changing the extruder head of the tool to an additive layer manufacturing extruder head and then using the additive layer manufacturing extruder head to deposit one or more beads on top of each other on the initial bead.

The method of bonding extruded beads of material onto the surface of a substrate, may comprising using a bead-on-plate extruder head to deposit the plurality of beads on the substrate. The bead-on-plate extruder head may have a means, such as a recess on the bottom surface that in use faces the substrate, which can be used to space each bead a set distance from an adjacent, already deposited bead. The recess may be designed to accommodate a bead, or at least part of a bead, which has already been deposited by the tool. This may allow the beads to be deposited close together without the tool hitting an adjacent bead.

The recess may have the same height as, or a height greater than a bead that has been deposited by the bead-on-plate extruder head. This is so that the bead can be accommodated within the channel without impairing the deposition of further beads. The position of the recess on the extruder head may determine the minimum distance between two beads deposited by the tool.

The bead-on-plate extruder head may be used to deform a first area of the surface of the substrate; extrude extrusion material to form extrudate; and deposit the extrudate on the surface of the substrate to form a first bead of material on the first area of the surface of the substrate which is bonded to the substrate. The bead-on-plate extruder head may then be moved to a second location, which may be determined by accommodating the first bead in a recess in the extruder head housing. Once moved the bead-on-plate extruder head may then be used to deform a second area of the surface of the substrate; and deposit extrudate on the second area of the surface of the substrate to form a second bead of material on the substrate which is bonded to the substrate. The same extruder head may be used in the same manner a number of times to allow the deposition of a plurality of equally spaced stringer beads on the component. The recess may be used to set the distance between adjacent beads.

The method of forming an extruded plate on the surface of the component may comprise using a bead-on-plate extruder head to deposit a series of spaced apart stringer beads on the surface of the component (for example as described above) and then changing to a butt joining extruder head and performing an effective butt joint in the channels between adjacent stringer beads to surface plate the component.

To perform a multi-pass joint between two components, a butt joining extruder head or a fillet joining extruder head (depending on the geometry of the gap between the two components to be joined), may be used to form an initial joint (which may be a butt joint or a fillet joint respectively) between the two components. The head of the tool may then be changed to a bead-on-plate extruder head and the tool may then be used to extrude and bond a first bead on the initial joint. The first bead may be spaced from each of the two components and be bonded only to the underlying initial joint. The head of the tool may then be changed to a butt joining extruder head or a fillet joining extruder head (depending on the geometry of each of the gaps between the first bead and two components to be joined). The tool may then be used to form a butt joint or fillet joint on each side of the initial bead to bond the initial bead to the components.

If the multi-pass joint has additional layers, the method may comprise changing back to the bead-on-plate extruder head, depositing one or more beads in the gap between the two components and changing to the butt or fillet joining head (as required by the geometry) and joining the deposited beads to the components and/or each other.

Certain preferred embodiments of the present invention will now be described by way of example only with reference to the accompanying drawings, in which:

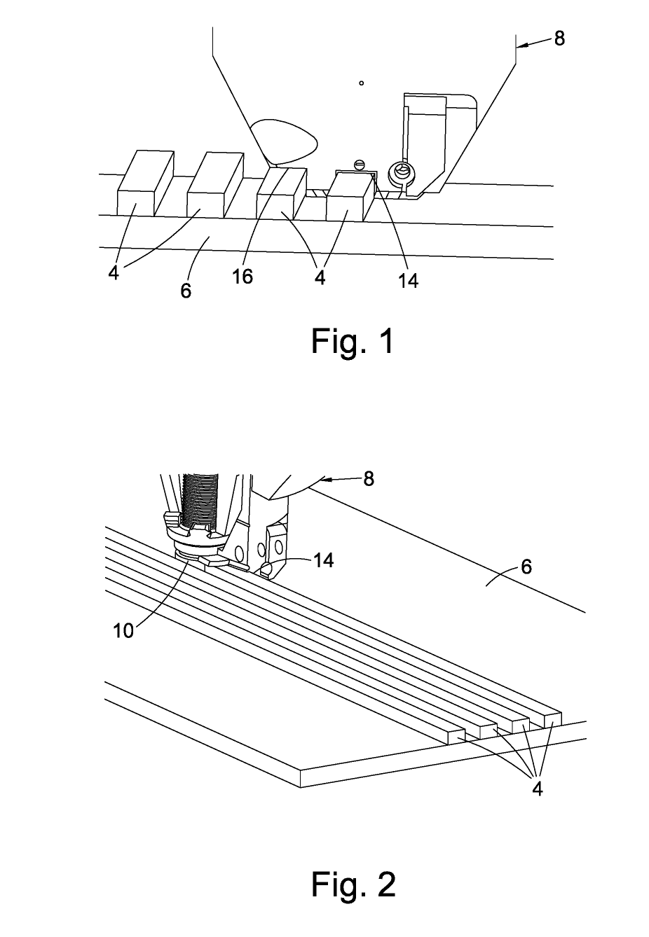

FIG. 1 shows bead-on-plate deposition;

FIG. 2 shows another view of bead-on-plate deposition;

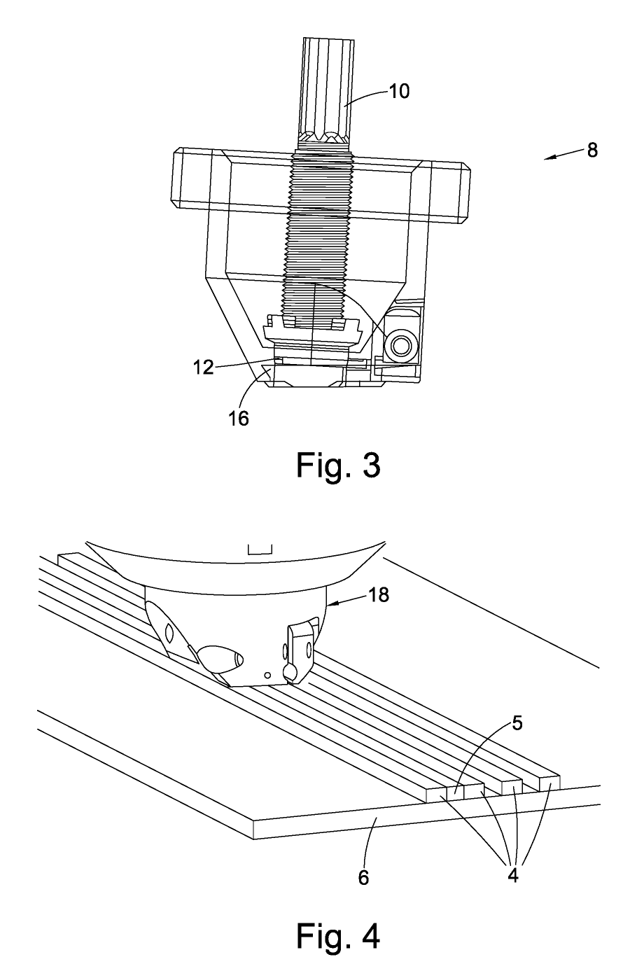

FIG. 3 shows an extruder head for bead-on-plate deposition;

FIG. 4 shows a surface plating technique;

FIG. 5 shows an extruder head for butt joining;

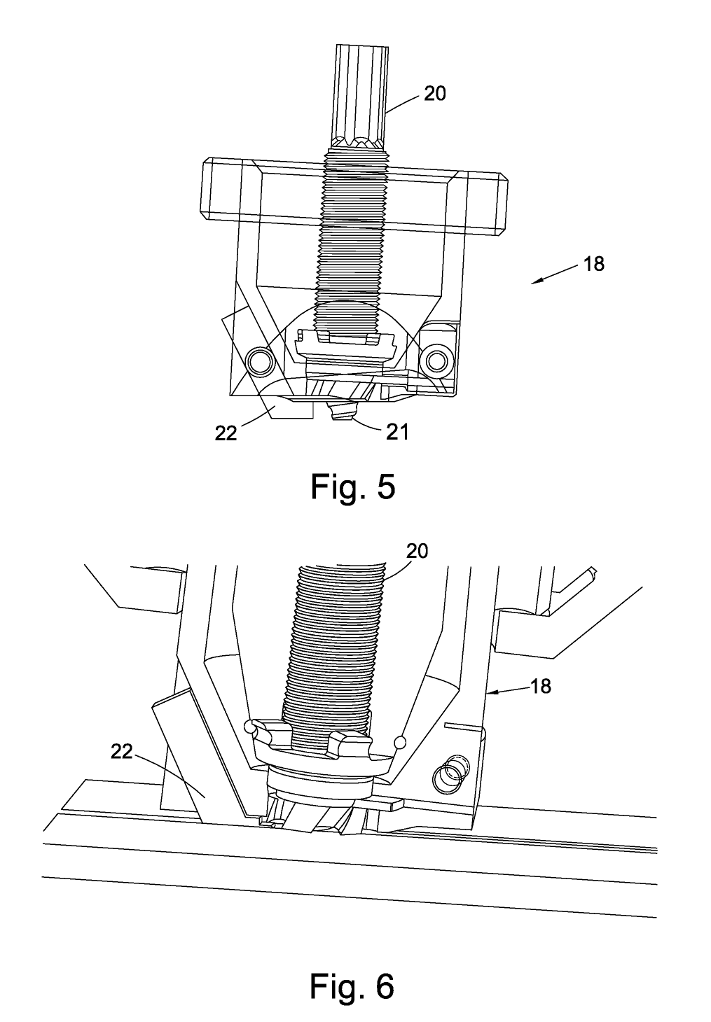

FIG. 6 shows the extruder head for butt joining being used;

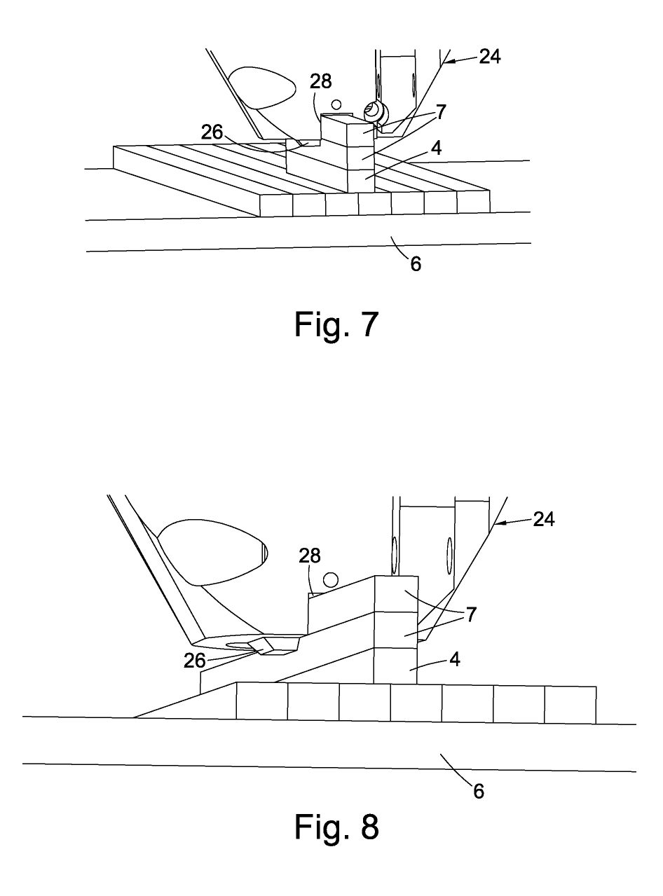

FIG. 7 shows additive layer manufacturing;

FIG. 8 shows another view of additive layer manufacturing;

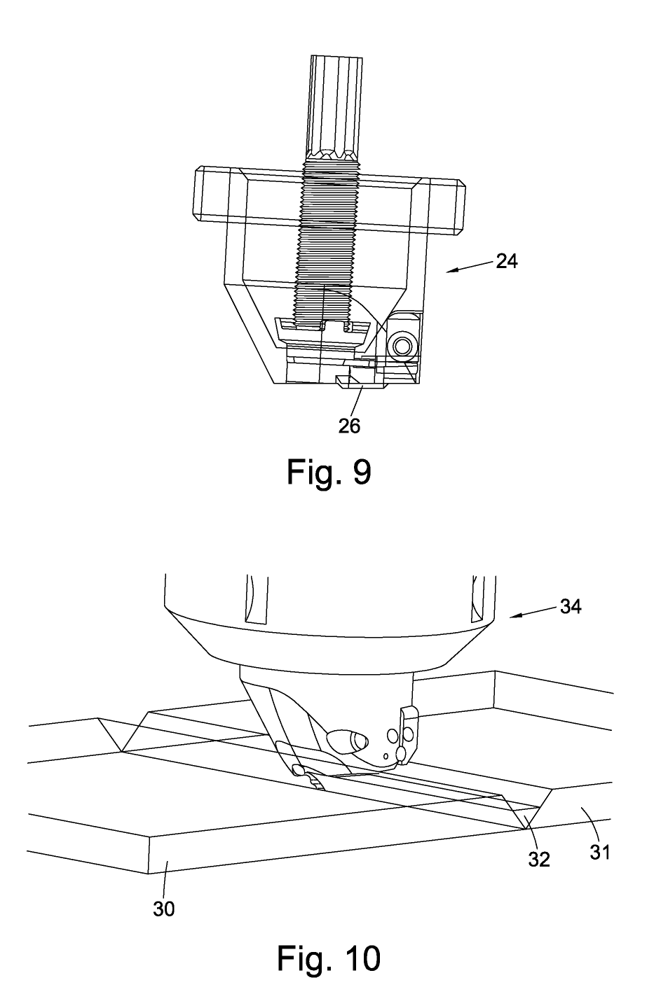

FIG. 9 shows an extruder head for additive layer manufacturing;

FIG. 10 shows a first stage of multi-pass joining;

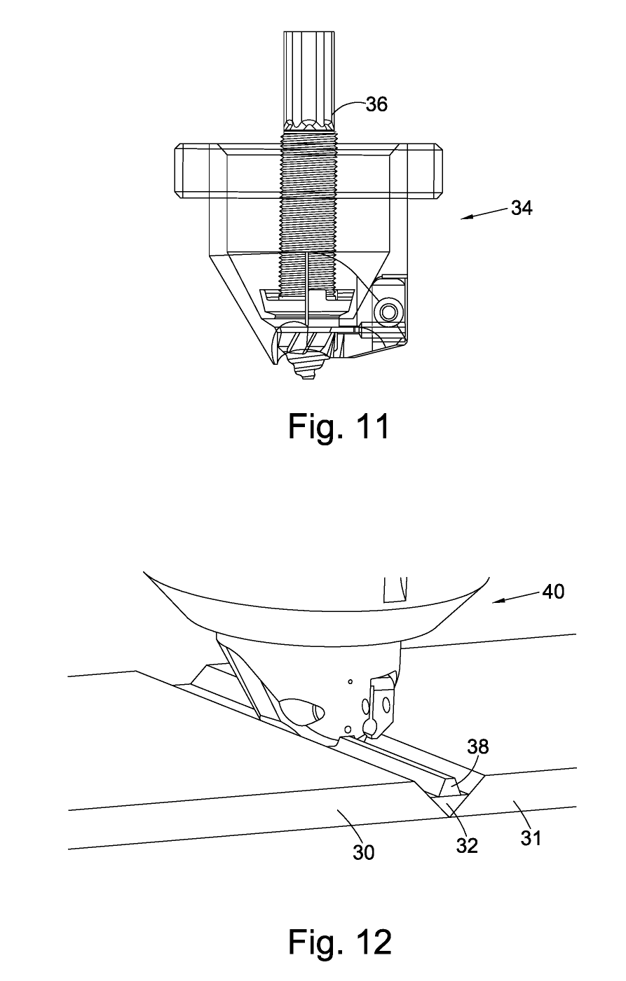

FIG. 11 shows an extruder head for the first stage of multi-pass joining;

FIG. 12 shows a second stage of multi-pass joining;

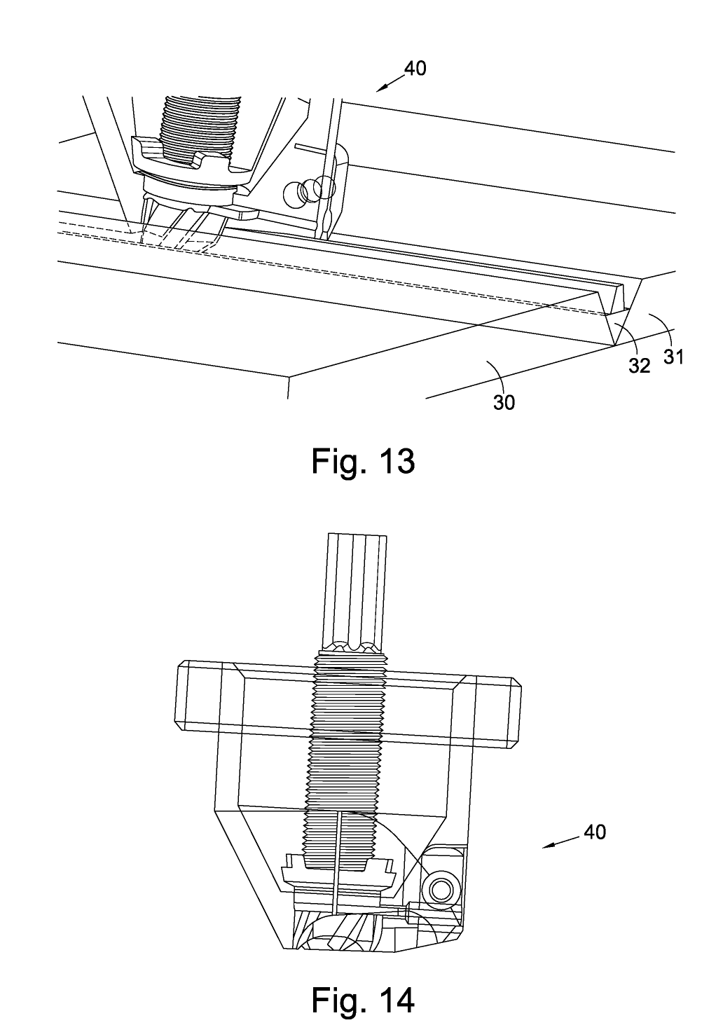

FIG. 13 shows another view of the second stage of multi-pass joining;

FIG. 14 shows an extruder head for the second stage of multi-pass joining;

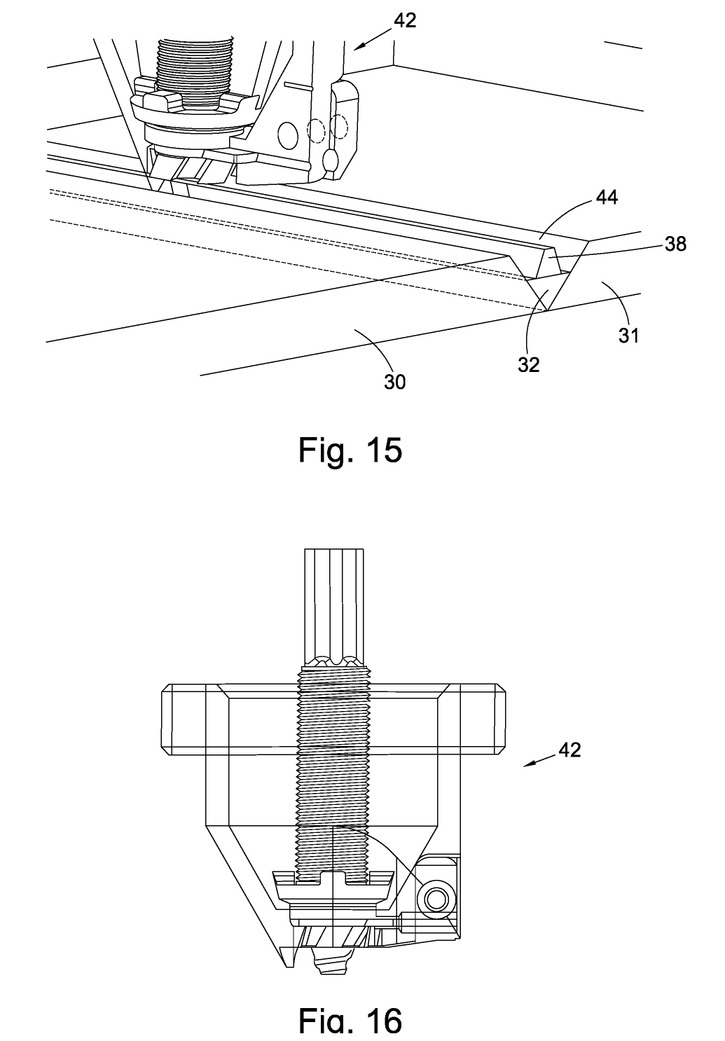

FIG. 15 shows a third stage of multi-pass joining;

FIG. 16 shows an extruder head for the third stage of multi-pass joining;

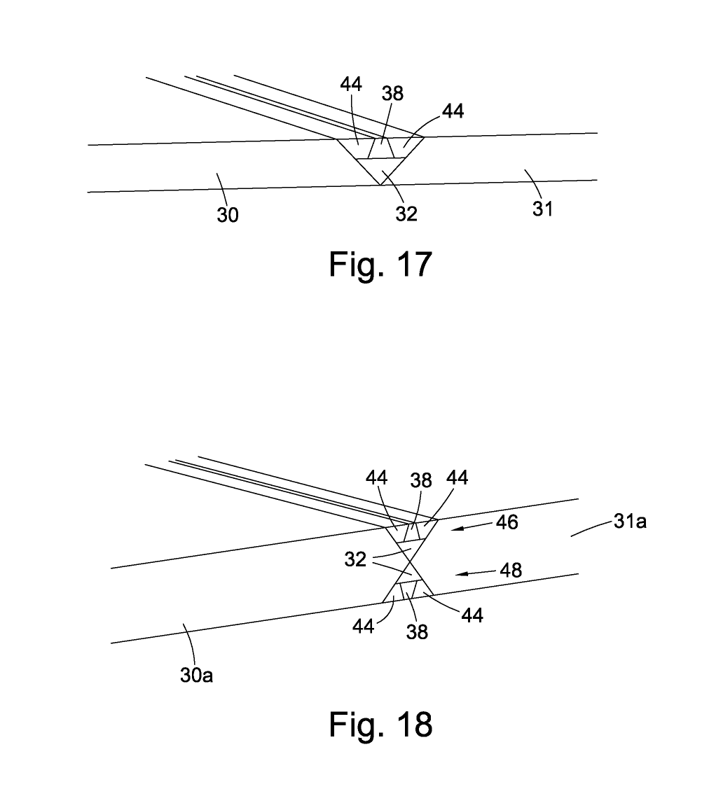

FIG. 17 shows a completed multi-pass joint;

FIG. 18 shows a double sided multi-pass joint; and

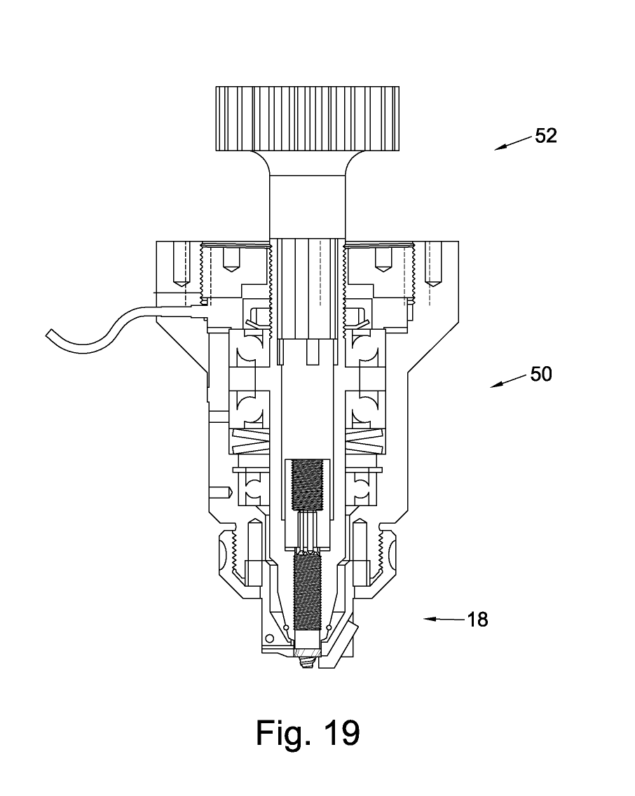

FIG. 19 shows a hybrid bonding and extrusion tool with an extruder head connected to a drive mechanism.

FIGS. 1 and 2 illustrate a bead-on-plate deposition method which is a method of bonding an extruded bead 4 of material onto the surface of a substrate 6. An extruder head 8 for this method is shown in FIG. 3. In this method a bead-on-plate extruder head 8 is used to extrude and deposit a bead of metal material 4 on a metal substrate 6. The method comprises deforming the surface of the substrate 6. This may be achieved by using a part of the extruder head 8 (such as a rotating spindle 10) to deform the substrate 6 ahead of where the extrudate is deposited or alternatively or additionally the force of the extrudate being deposited may deform the substrate 6. The method also comprises extruding extrusion material to form extrudate and depositing the extrudate on the surface of the substrate 6 to form a bead 4 of material on the substrate 6 which is bonded to the substrate 6.

FIG. 3 shows a partial cross section of an extruder head for bead-on-plate deposition. The extrusion material may be fed through an extrusion chamber 12 around the rotating spindle 10 and forced backwards (compared to the direction of travel of the tool) through a rear facing channel 14 to form the bead 4. When a plurality of beads 4 are being deposited as shown in FIGS. 1 and 2, the bead-on-plate extruder head 8 may comprise a recess 16. The recess 16 is sized to accommodate the already deposited adjacent bead 4 and can be used to space each bead 4 a set distance from an adjacent bead 4.

It may be desirable to deposit a plurality of beads 4 on a substrate 6 so that a surface plating technique can be performed as shown in FIG. 4. Once a plurality of beads 4 have been deposited on a substrate 6, a butt joining extruder head 18 may be used to deform and extrude extrusion material into the channels between the deposited beads 4 to form a butt joint 5 between adjacent beads. Once this is repeated for each of the channels an extruded plate is formed on, and bonded to the substrate 6.

FIG. 5 shows an extruder head 18 for butt joining that may be used in the surface plating technique to join adjacent deposited beads 4. The butt joining extruder head 18 comprises a rotating spindle 20 with a spindle tip 21 that contacts and deforms the base and sides of the channel before extrusion material is extruded into the channel. The butt joining extruder head 18 also comprises a sealing protrusion 22 that is located in the channel in use to prevent flash leakage ahead of the tool.

FIG. 6 shows another view of the butt joining extruder head 18 being used to perform a butt joint.

FIGS. 7 and 8 show an additive layer manufacturing extruder head 24 being used to perform additive layer manufacturing. The additive layer manufacturing extruder head 24 is shown in FIG. 9.

In this technique an extruded bead 7 is deposited on an already deposited extruded bead 4.

Thus, the method comprises deforming the surface of a substrate (which in the examples shown in FIGS. 7 and 8 is a surface plate that has been deposited according to the method described in connection with FIG. 4), extruding extrusion material to form extrudate and depositing the extrudate on the surface of the substrate to form a first bead 4 of material on the substrate which is bonded to the substrate. This first step may be the same as the bead-on-plate deposition method described in connection with FIGS. 1 and 2.

Next, the method may comprise deforming a surface of the first bead 4 of material on the surface of the substrate and depositing extrudate on surface of the first bead 4 of material on the substrate to form a second bead 7 of material on the first bead 4 of material on the substrate. This process of deforming the surface of a deposited bead and depositing extrudate on surface of the bead may be repeated to form a stack of beads 7 on top of each other as shown in FIGS. 7 and 8.

The additive layer manufacturing extruder head 24 may comprise a guiding protrusion 26 on either side of an extrusion channel 28. These guiding protrusions 26 may be used to ensure that the bead 7 being deposited is correctly deposited on the already deposited bead of material.

FIGS. 10, 12, 13 and 15 show a multi pass joining technique. This technique may be used to join thick plates 30, 31 when a single pass cannot form an adequate joint between the two plates 30, 31.

As a first stage (shown for example in FIG. 10) an initial joint 32 is formed between the two plates 30, 31. Given the V-shaped geometry of the gap between the two plates 30, 31, this initial joint is a fillet joint. Thus, this initial joint 32 is formed using a fillet join extruder head 34.

The method of joining two thick components 30, 31 comprises deforming the surface of each of the components 30, 31 which are to be joined. This may be achieved using a rotating spindle 36 which has a tapered tip to be received in the gap between the two components 30, 31. The extruder head 34 is then used to extrude extrusion material to form extrudate and depositing the extrudate between the two components such that it contacts the surface of each of the components 30, 31 to form an initial joint 32 between the components 30, 31.

Once the initial joint 32 has been formed, a bead 38 may be deposited on the initial joint 32 in a gap between the two components 30, 31. The method may comprise deforming a surface of the initial joint 32 and depositing further extrudate on the initial joint 32 between the two components 30, 31 to form a bead 38 as shown in FIGS. 12 and 13. The bead 38 may be extruded and deposited by a bead-on-plate extruder head 40.

The bead 38 may be located in the centre of the gap between the two components 30, 31 so as to leave a channel on either side of the bead 38.

The bead-on-plate extruder head 40 may be specially designed to have angled sides (see for example FIGS. 11 and 12) to allow it to deposit bead 38 on the initial joint 32 in the gap between the two components 30, 31.

Once the bead 38 has been deposited, a butt joint extruder head 42 may be used to deform and deposit extrudate into the channels formed on either side of the bead 38. First one channel is filled and then the other channel is filled. This fills the channels with second and third beads 44 which are each bonded to the first bead 38, the initial joint 32 and a respective one of the components (30 or 31).

Once the second and third beads 44 have been extruded and deposited into the channels a completed multi-pass joint is formed as shown in FIG. 17.

In the case of thick components 30a, and 31a to be joined and/or or when it is desirable the surface quality of the join on each side to be carefully controlled, a double-sided joint may be formed in which a first joint 46 is formed from a first side of the two components and a second joint 48 is formed from an opposite second side of the two components.

In the case of particularly thick components 30a, 31a to be joined, the joint on each side may be a multi-pass joint formed by the method described in connection with FIGS. 10 to 17.

Thus, the method of joining two thick components 30a, 31a may comprise deforming at least part of the surface of each of the components 30a, 31a which are to be joined, extruding extrusion material to form extrudate, depositing extrudate from a first direction between the two components 30a, 31a such that it contacts the surface of each of the components which has been deformed to form an initial joint 32 between the components, and depositing further extrudate from a second direction between the two components to form an additional joint 32 between the components 30a, 31a. The direction of the deposition of extrudate may be changed by moving the extrusion tool and/or the two components to be joined.

FIG. 19 shows a tool 50 for performing the above described methods. The tool 50 comprises a drive mechanism 52 and extruder head 18 (shaded in grey for clarity). Whilst the tool 50 is shown with a butt joining extruder head 18, the extruder head may be interchangeable with any of the above described extruder heads 8, 18, 24, 34, 40, and/or 42. The method may comprise changing the extruder head between steps of the method being performed. For example, in the case of the surface plating method, initially the bead on plate extruder head 8 may be used to deposit a plurality of equally spaced beads 4 with channels therebetween and then the butt join extruder head 18 may be used to butt join adjacent beads 4 together to form a surface plate.

1. A solid-state method of bonding an extruded bead of metal material onto the surface of a metal substrate, the method comprising:
deforming a first area of the surface of the substrate;
extruding extrusion material to form extrudate; and
depositing the extrudate on the surface of the substrate to form a first bead of material on the substrate which is metallically bonded to the substrate,
deforming a second area of the surface of the substrate;
depositing extrudate on the second area of the surface of the substrate to form a second bead of material on the substrate which is bonded to the substrate, wherein the second area is spaced from the first area of the surface of the substrate such that the second bead of material is spaced from the first bead of material to form a channel therebetween,
deforming the surfaces of the channel; and
depositing extrudate in the channel to form a third bead of material on the substrate which is bonded to the substrate and the first and second beads of material.

2. A method according to claim 1, wherein when the extrudate is deposited to form the first bead of material it bonds only to the substrate onto which it has been extruded.

3. A method according to claim 1 or 2, wherein the substrate is a plate and the extruded beads are bonded to a planar surface of the plate.

4. A method according to claim 1, 2 or 3, wherein the step of deforming the surface of the substrate is done before the extrudate is deposited onto the surface of the substrate such that the extrudate is deposited onto a deformed surface of the substrate.

5. A method according to any preceding claim, wherein the first, second and third beads form an extruded plate on the surface of the substrate.

6. A method according to any preceding claim, wherein the steps of depositing layers of material on the substrate which are spaced apart is repeated more than two times so as to create a series of channels, and wherein the series of channels are each deformed and have extrudate extruded therein to form a surface plate on the substrate.

7. A solid-state extrusion and bonding additive layer manufacturing method of bonding an extruded bead of metal material onto the surface of a metal substrate, the method comprising:
deforming a surface of the substrate;
extruding extrusion material to form extrudate; and
depositing the extrudate on the surface of the substrate to form a first bead of material on the substrate which is metallically bonded to the substrate;
deforming a surface of the first bead of material on the surface of the substrate; and
depositing extrudate on surface of the first bead of material on the substrate to form a second bead of material on the first bead of material on the substrate.

8. A method according to claim 7, comprising deforming a surface of the second bead of material bonded to the first bead of material; and depositing extrudate on surface of the second bead of material to form a third bead of material on the second bead of material.

9. A method of using an extrusion and bonding tool to perform the method of any preceding claim.

10. A method according to claim 9, wherein the method comprises changing an extruder head of the tool.

11. A solid-state method of joining two metal components, the method comprising:
extruding metal extrusion material to form extrudate;
depositing extrudate between the two components such that it contacts each of the components to form an initial joint between the components;
deforming a surface of the initial joint; and
depositing further extrudate on the initial joint between the two components.

12. A method according to claim 11, wherein the further extrudate forms a first bead on the initial joint.

13. A method according to claim 12, wherein the first bead forms a first channel between itself and one of the two components and a second channel between itself and the other of the two components.

14. A method according to claim 13, wherein the method comprises:
deforming the surfaces of the first channel;
depositing extrudate in the first channel to form a second bead which is bonded to the initial joint, one of the components and the first bead of extrudate;
deforming the surfaces of the second channel; and
depositing extrudate in the second channel to form a third bead which is bonded to the initial joint, the other of the two components and the first bead of extrudate.

15. A method according to claim 14, wherein the initial joint, and the first, second and third beads together form a multi-pass joint between to the two components.

16. A method according to claim 14 or 15, wherein the first, second and third beads together form a second layer on the initial joint which forms a first layer.

17. A method according to any preceding claim, wherein the two components are arranged to have a gap therebetween which is V-shaped.

18. A method according to claim 17, wherein the initial joint is formed in the narrowest part of the V-shaped gap.

19. A method of using an extrusion and bonding tool to perform the method of any preceding claim.

20. A method according to claim 19, wherein the method comprises changing an extruder head of the tool.

21. A method according to any of claims 11 to 20, wherein the initial joint is formed using a fillet join extruder head.

22. A method according to any of claims 11 to 21, when dependent on claim 12, wherein the first bead is formed using a bead-on-plate extruder head.

23. A method according to any of claims 11 to 22, when dependent on claim 14, wherein the second and third beads are formed using a butt joining extruder head.

24. A method of joining two components, the method comprising:
performing the method of any of claims 11 to 23 from a first direction to form a first joint between the components; and
repeating the method of any of claims 11 to 23 from a second direction to form a second joint between the components.

25. A method according to claim 24, wherein the first joint and second joint together form a double sided joint.

26. An extrusion and bonding tool which is arranged to perform the method of any preceding claim.
